(19) United States
(12) Patent Application Publication
(10) Pub. No.: US 2002/0117788 A1
(43) Pub. Date: Aug. 29, 2002

(54) Hydraulic bearing

(76) Inventor: John Philip West, Notts (GB)

Correspondence Address: KENYON & KENYON, ONE BROADWAY, NEW YORK, NY, 10004, US

(21) Appl. No.: 10/034,311

(22) Filed: Dec. 19, 2001

(30) Foreign Application Priority Data
Dec. 21, 2000 (DE) 100 64 330.2

(51) Int. Cl. F16F 13/00

(52) U.S. Cl. 267/140.12

(57) ABSTRACT

A hydraulic bearing including a journal bearing (1) and a supporting bearing (2) which are connected to each other by a spring body (3) made of a rubber elastic material and border on at least one working space (4) and at least one compensating space (5), the working space (4) and the compensating space (5) being each filled with a damping fluid and communicating through a damping device (6) so as to conduct fluid. Damping fluid can flow through the damping device (6) when the journal bearing (1) and supporting bearing (2) are radially displaced relative to one another.

### BACKGROUND OF THE INVENTION

1. Field of the Invention

The present invention relates to a hydraulic bearing which includes a journal bearing and a supporting bearing which are joined by a spring body made of a rubber elastic material and border on at least one working space and at least one compensating space, the working space and the compensating space being each. filled with a damping fluid and being connected in fluid communication by a damping device.

2. Description of Related Art

Such hydraulic bearings are known in general and are used as engine mounts, for example. The direction of damping is parallel to the axis of the hydraulic bearing.

### SUMMARY OF THE INVENTION

It is an object of the invention to provide a hydraulic bearing of the type described above so that in addition to damping in the direction parallel to the axis of the hydraulic bearing, it has a damping direction extending in the radial direction.

These and other objects of the invention are achieved by a hydraulic bearing wherein a damping fluid can flow through the damping device when the journal bearing and the supporting bearing are radially displaced relative to one another. It is advantageous here that the induced vibrations are dampened not only in the axial direction but also transversely to the axis of the hydraulic bearing. Vibrations caused by load changes, acceleration or braking can be dampened in an excellent manner by such a bearing, as can vibrations induced in the axial direction of the bearing, e.g., when driving over a curbstone. High-frequency, low-amplitude vibrations induced by the roadway surface, for example, and/or the tire profile of a motor vehicle can be isolated as needed, e.g., using a suitable design of the partition between the working space and the compensating space. The components needed for isolation of high-frequency, low-amplitude vibrations, such as a membrane made of a rubber elastic material arranged inside a nozzle cage between the working space and the compensating space, is known in the related art and can be provided as needed without one skilled in the art, who is familiar with the design of hydraulic bearings, having to make any inventive contribution.

### BRIEF DESCRIPTION OF THE DRAWINGS

The present invention will be described in greater detail with reference to the following drawings, wherein:

FIG. 1 shows a first exemplary embodiment of a hydraulic bearing, shown in longitudinal section.

FIG. 2 shows a longitudinal section of the hydraulic bearing in FIG. 1, rotated by 90°.

FIG. 3 shows a sectional view along line A-A of the hydraulic bearing in FIG. 1.

FIG. 4 shows a longitudinal section of a second embodiment of a hydraulic bearing.

FIG. 5 shows a longitudinal section of the hydraulic bearing in FIG. 4, rotated by 90°.

FIG. 6 shows a cross section through the hydraulic bearing in FIG. 4 along line. B-B.

FIG. 7 shows a longitudinal section of a third embodiment of a hydraulic bearing.

FIG. 8 shows a a fourth embodiment of a hydraulic bearing according to the present invention.

FIG. 9 shows a fifth embodiment in longitudinal section along line C-C of FIG. 10.

FIG. 10 shows a cross-sectional diagram of the hydraulic bearing in FIG. 9.

FIG. 11 shows a longitudinal section of a sixth embodiment.

FIG. 12 shows a longitudinal section of a seventh embodiment of a hydraulic bearing according to the present invention.

FIG. 13 shows a longitudinal section of an eighth embodiment of a hydraulic bearing.

FIG. 14 illustrates an alternative embodiment of a partition formed by a nozzle cage, partition being composed of a top part and a bottom part, separated axially by a membrane that can vibrate axially to isolate high-frequency, low-amplitude vibrations.

### DETAILED DESCRIPTION OF THE INVENTION

The. damping device can preferably be formed by a partition between the working space and the compensating space, with the partition having at least one damping channel. The damping effect is based on the fact that the damping fluid inside the damping channel can move back and forth out of phase, preferably in phase opposition to the induced vibrations. The greater the mass of the fluid inside the damping channel, the lower may be the frequencies to be damped.

The working space and the compensating space can be arranged adjacent to one another in the axial direction and may be separated by the partition. This design corresponds essentially to the design of conventional hydraulic bearings, damping fluid moving back and forth between the working space and the compensating space through the damping channel inside the partition in order to damp low-frequency, high-amplitude vibrations. Such hydraulic bearings have a comparatively compact design in the radial direction, the length of the damping channel being variable, for example, by its running multiply coiled inside the partition.

The working space may have at least one fluid pocket with a variable volume extending in the axial direction. When the journal bearing is radially displaced toward the supporting bearing, the volume of the fluid pocket is reduced, for example, with the displaced portion of the fluid being accommodated in the compensating space. If the hydraulic bearing springs back into its starting position and the fluid pocket is restored to its original volume, the previously displaced portion of the fluid will have moved out of the compensating space and back into the fluid pocket, e.g., through the damping channel. The deciding factor for damping in the. radial direction is the fact that, as the journal bearing is radially displaced relative to the supporting bearing, a portion of the fluid. is displaced from the working space into the compensating space through the, damping device. Because of the fluid pocket having a variable volume extending in the axial direction, this hydraulic bearing is advantageously similar on the outside to such hydraulic bearings that dampen vibrations only in the axial direction.

The fluid pocket may be designed to be essentially kidney-shaped, for example, and it may extend essentially in a semicircle around the core of the journal bearing. Portions of the fluid displaced from the fluid pocket at the induction of radial vibrations escape from the fluid pocket axially, e.g., through a damping channel, into the compensating chamber.

The working space may have two fluid pockets with a variable volume extending in the peripheral direction, connected by at least one throttle opening. The fluid pockets may be designed to be essentially kidney shaped and may extend essentially in a semicircle around the core of the journal bearing. To damp radially induced vibrations, a portion of the fluid is displaced from one fluid pocket into the other fluid pocket and back again through the throttle opening. There is the possibility that additional portions of the fluid may be guided through the damping channel and into the compensating space, depending on the flow resistance of the throttle opening in comparison with the flow resistance of the damping channel.

The damping channel or the throttle opening may be arranged in the core of the journal bearing. It is advantageous here that the hydraulic bearing has a simple and compact design on the whole, since the core, which is present anyway, is used as a damping device. The damping channel or the throttle opening may be arranged in a spiral in the outside area of the core, for example, the fluid components being directed from one fluid pocket into the other through the damping channel or the throttle opening in the core. Vibrations induced in the radial direction are damped thereby.

The damping channel or the throttle opening may be coiled in the core. This yields a great length of the damping device in a space-saving design for being able to damp low-frequency, high-amplitude vibrations.

The two fluid pockets can be separated hydraulically from the working space and/or compensating space. It is advantageous here that the fluid pockets can be combined with conventional hydraulic bearings. Therefore, there is no exchange of fluid between the fluid pockets and the working space or the fluid pockets and the compensating space. The following can be said regarding the functioning of such a hydraulic bearing.

Vibrations induced axially in the hydraulic bearing are damped and/or isolated by the methods known from the related art. For damping of low-frequency, high-amplitude vibrations, a portion of the fluid is displaced out of the working space and into the compensating space, and vice versa, through the damping channel. The induced vibrations are damped in this way. For example, to isolate high-frequency, low-amplitude vibrations, a membrane may be movable back and forth within the partition designed as a nozzle cage, in which case the partition may be designed to be loose or clamped. Such a hydraulic bearing functions independently of the fluid pockets. The fluid is hydraulically blocked within the working space and compensating space when vibrations are induced in the radial direction; only the fluid inside the two fluid pockets is displaced back and forth in the radial direction, thereby damping vibrations induced in the radial direction.

According to another embodiment, it is possible for both of the fluid pockets to be connected to the working space in a fluid-conducting manner. The fluid is displaced between the two fluid pockets by the fact that the damping fluid is forced out of one of the fluid pockets and into the working space, e.g., through a damping channel, and damping fluid from the working space is received into the second fluid pocket through another damping channel to the same extent. Then there is no direct exchange of fluid between the two fluid pockets. Such a hydraulic bearing can be adjusted especially well to the prevailing conditions of the. given application due to the fact that each of the fluid pockets communicates with the working space through a damping channel, so that fluid can be conducted.

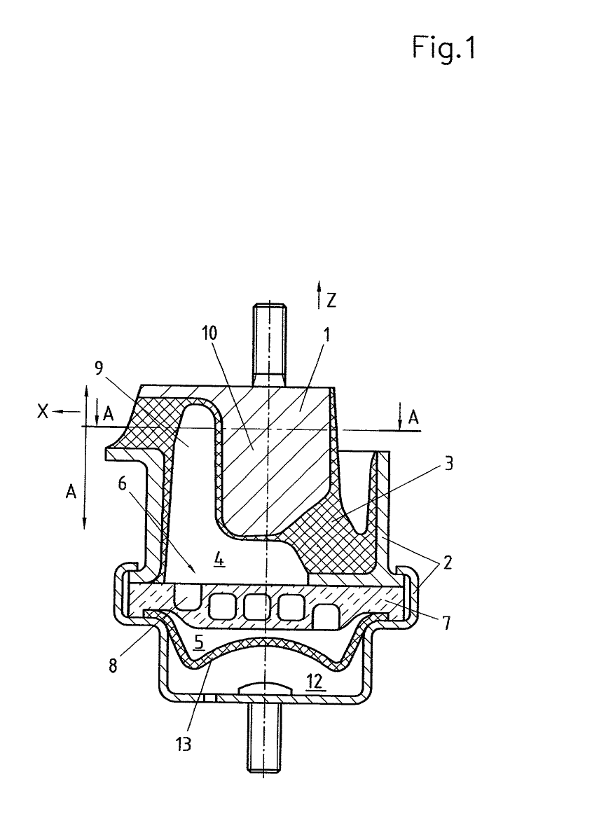

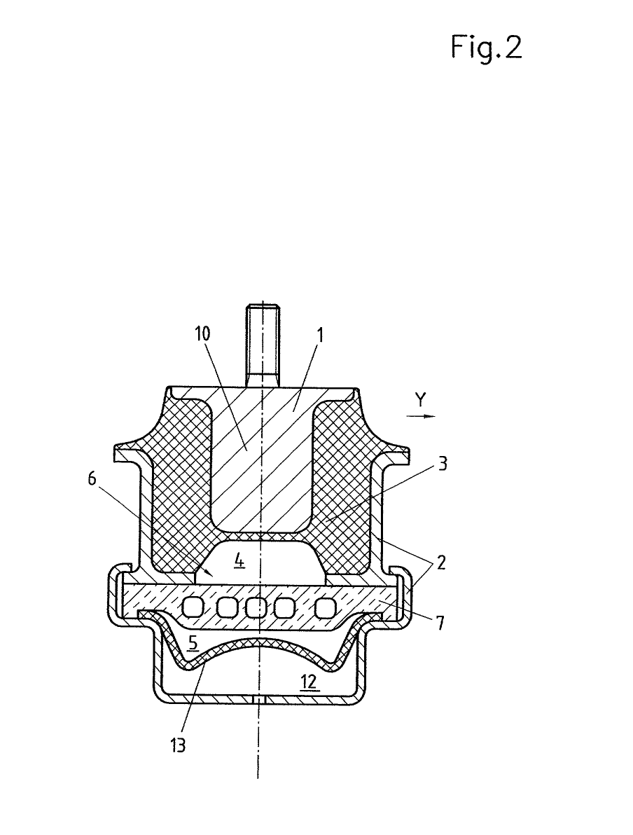

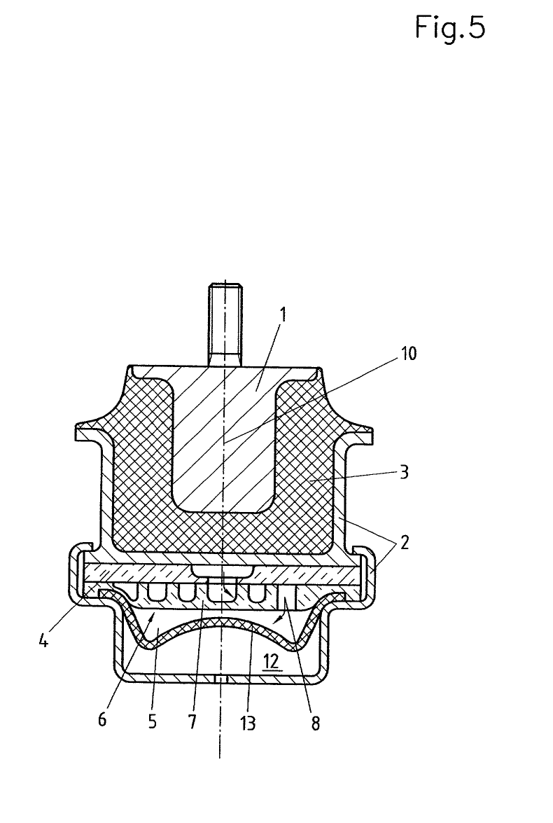

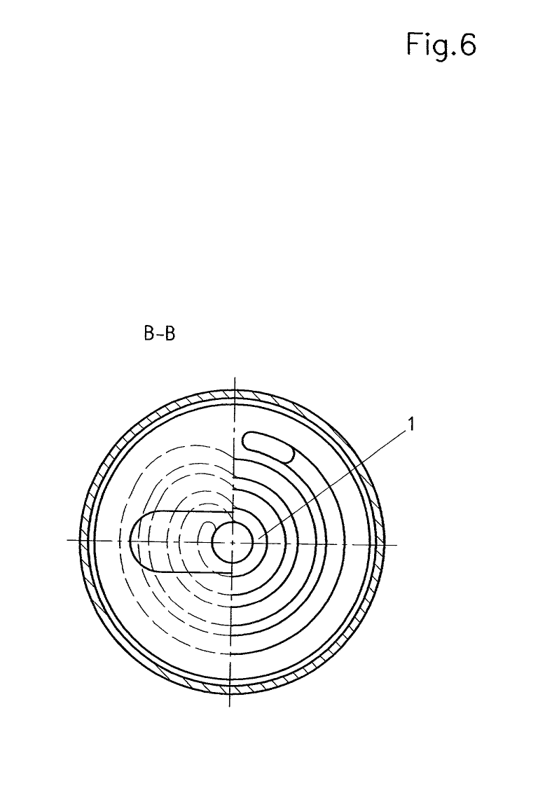

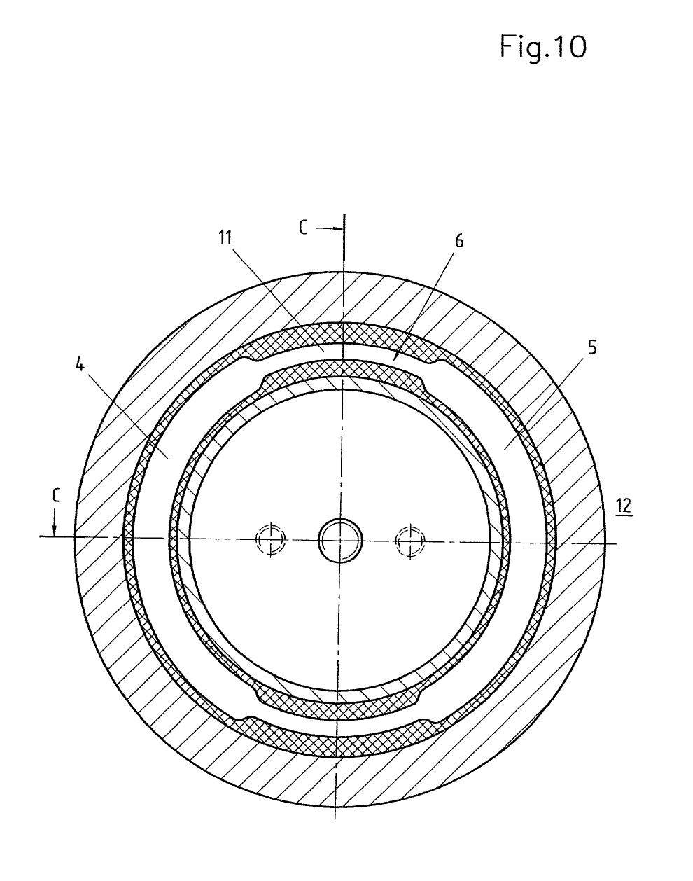

The compensating space may be bordered on the side facing the surroundings by a membrane designed like rolling bellows so it can accommodate a volume in an essentially pressure-free manner. It is advantageous here that there is no unwanted dynamic hardening of the hydraulic bearing. Each of the hydraulic bearings from FIGS. 1 through 13 has a journal bearing 1 and a supporting bearing 2 joined by spring body 3. Spring body 3 is made of a rubber elastic material, and together with journal bearing 1 and supporting bearing 2. it borders on a working space 4 and on a compensating space 5. Working space 4 and compensating space 5 are filled with a damping fluid and communicate through damping device 6 in a fluid-conducting manner. Damping fluid can flow through damping device 6 in response to a relative radial displacement of journal bearing 1 and supporting bearing 2.

FIGS. 1 through 3 illustrate a first embodiment of a hydraulic bearing. In this exemplary embodiment, damping device 6 is formed by a partition 7 positioned between working space 4 and compensating space 5. Partition 7 has a damping channel 8 through which damping fluid can flow for damping of radially and axially induced vibrations. Working space 4 and compensating space 5 are arranged side by side in the axial direction and are separated from one another by partition 7.

To achieve damping in the radial direction, a variable volume fluid pocket 9 extending axially and asymmetrically inside working space 4, is essentially kidney shaped and extends essentially in a semicircle around core 10 of the journal bearing.

The following can be said regarding the functioning of the hydraulic bearing:

When low-frequency, high-amplitude vibrations are induced in the axial direction of the hydraulic bearing, journal bearing 1 is displaced axially in the direction of partition 7, so that damping fluid is delivered through damping channel 8, from working space 4 into compensating space 5. The damping fluid is received in compensating space 5 in an essentially pressure-free manner through membrane 13, which has a roller bellows design. Upon the rebounding of journal bearing 1, the damping fluid which was previously conveyed into compensating space 5 is conveyed back into working space 4 through damping channel 8. Displacement of damping fluid back and forth in damping channel 8 from working space 4 into compensating space 5 and back again through damping channel 8 takes place 180 degrees out of phase with the induced vibration.

Damping of radially induced vibrations is accomplished in such a way that when journal bearing 1 is radially displaced with respect to supporting bearing 2, fluid pocket 9 is at first compressed, forcing the damping fluid in it into compensating space 5 through damping channel 8. However, when journal bearing 1 resumes the position shown here, the previously displaced damping fluid is received again in the working space and fluid pocket 9, which forms a part of the working space, through damping channel 8.

The hydraulic bearing has a simple and compact design and thus is especially advantageous from a manufacturing technology and economic point of view.

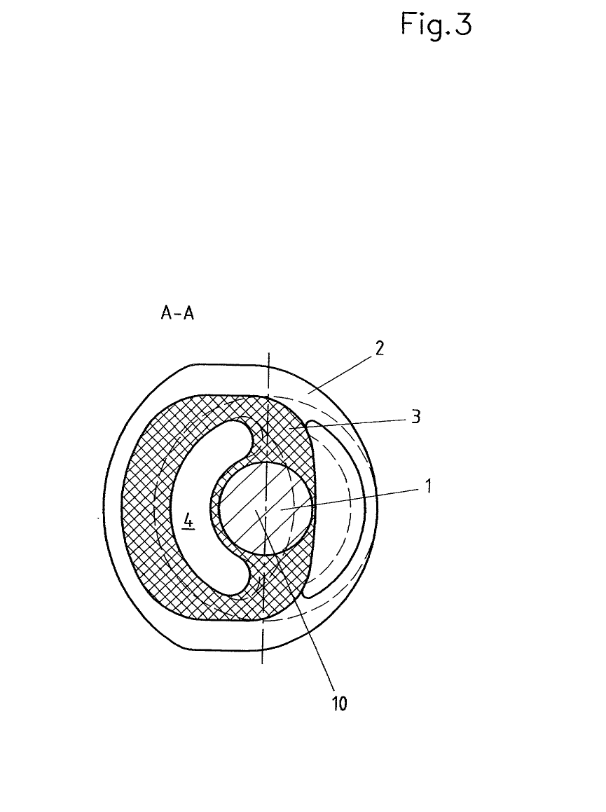

FIG. 3 illustrates the essentially kidney-shaped cross section of fluid pocket 9, with. fluid pocket 9 extending essentially in a semicircle around core 10 of journal bearing 1.

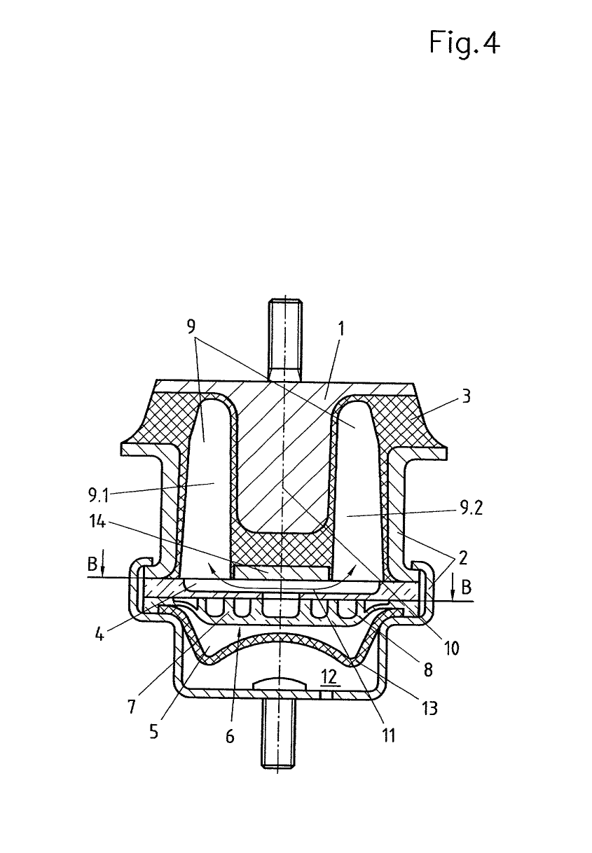

FIGS. 4 through 6 illustrate a second exemplary embodiment of a hydraulic bearing. In this embodiment, fluid pocket 9 is composed of two parts, including fluid pockets 9.1 and 9.2, each being kidney-shaped and each extending essentially in a semicircle around core 10 of journal bearing 1. Fluid pockets 9.1, 9.2 communicate so that fluid is conducted through a throttle opening 11, and damping fluid can flow through throttle opening 11 only for damping vibrations induced in the radial direction.

For damping low-frequency, high-amplitude vibrations in the axial direction, stop plate 14, which may be made of a polymer material, for example, comes in contact with partition 7, so that there is no exchange of fluid between the two fluid pockets 9.1, 9.2. Even without this essentially fluid-tight connection, there would be no exchange between the two fluid pockets 9.1, 9.2 in the event of damping vibrations induced in the axial direction, since in response to an axial load on the bearing, identical fluid pockets 9.1, 9.2 displace. and receive back the same amount of damping fluid at the same time. For damping axially induced vibrations, the damping fluid in fluid pockets 9.1, 9.2 is conveyed into compensating space 5 by passing through damping channel 8 inside partition 7.

In this exemplary embodiment, the damping fluid enters damping channel 8 centrally but leaves it radially in the outer area of partition 7.

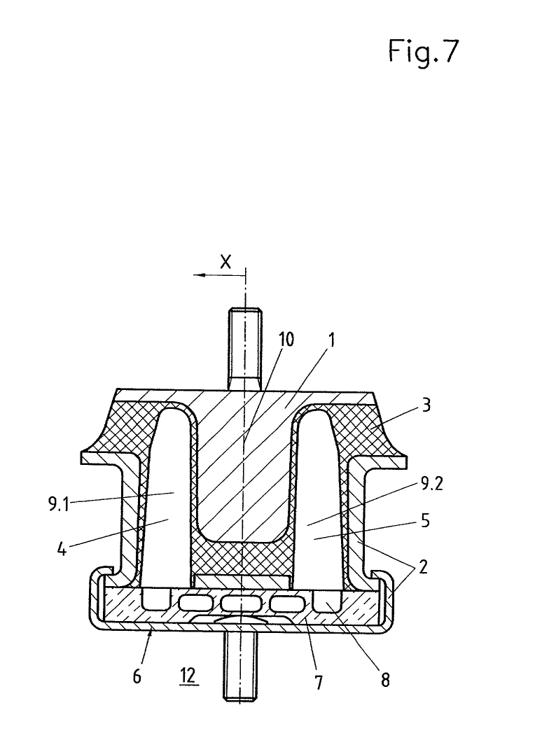

FIG. 7 illustrates a simplified exemplary embodiment of a hydraulic bearing.

The hydraulic bearing shown here is provided only for damping radially induced vibrations, the two fluid pockets 9.1, 9.2 not differing significantly in function from fluid pockets 9.1, 9.2 described in conjunction with FIG. 4. In this exemplary embodiment, both fluid pockets 9.1, 9.2 are designed as a working space 4 and an compensating space 5 and communicate so that fluid is conducted through a damping channel 8 inside partition 7. The length and/or cross section of damping channel 8 depends on the factors in the given application, the design and dimensioning of damping channel 8 being determinable by one skilled in the art without being inventively active.

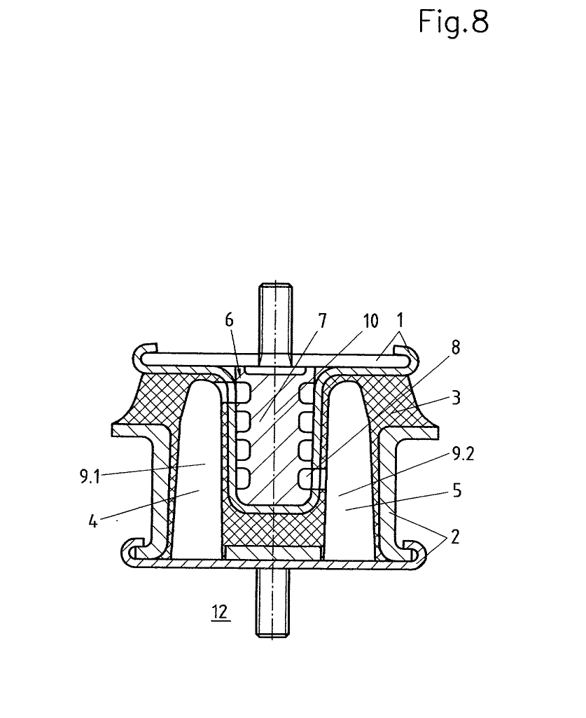

FIG. 8 illustrates another exemplary embodiment which differs from the exemplary embodiment according to FIG. 7 only in the design and arrangement of damping device 6. In this exemplary embodiment, damping device 6 is arranged in core 10 of journal bearing 1, surrounding the latter in a spiral shape.

As journal bearing 1 is radially displaced back and forth relative to supporting bearing 2, a portion of the damping fluid is displaced from one fluid pocket 9.1, the displaced damping fluid being accommodated by the other fluid pocket 9.2.

Then the fluid is displaced in the opposite direction. Displacement of fluid between fluid pockets 9.1 and 9.2 takes place 180 degrees out of phase with the radially induced vibration.

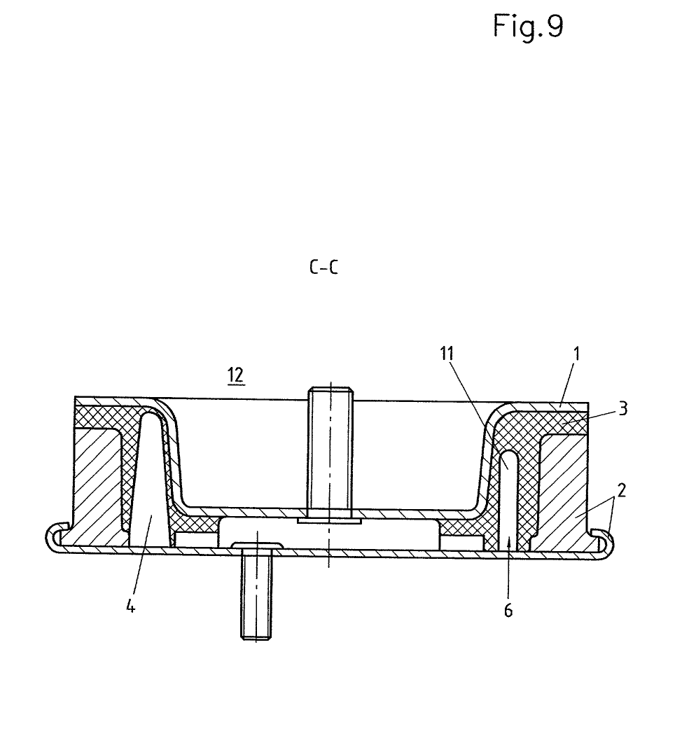

FIG. 9 illustrates another exemplary embodiment of a hydraulic bearing according to the present invention. In this exemplary embodiment, fluid displacement between the two fluid pockets 9.1, 9.2 takes place through a throttle opening 11 having a reduced cross section in comparison with fluid pockets 9.1, 9.2. During a radial displacement of journal bearing 1 and supporting bearing 2 relative to one another, a portion of the damping fluid is displaced from fluid pocket 9.1 into fluid pocket 9.2 and vice versa through the two throttle openings 11 distributed evenly in the circumferential direction. Each throttle opening 11 is bordered by the elastomeric material of spring body 3.

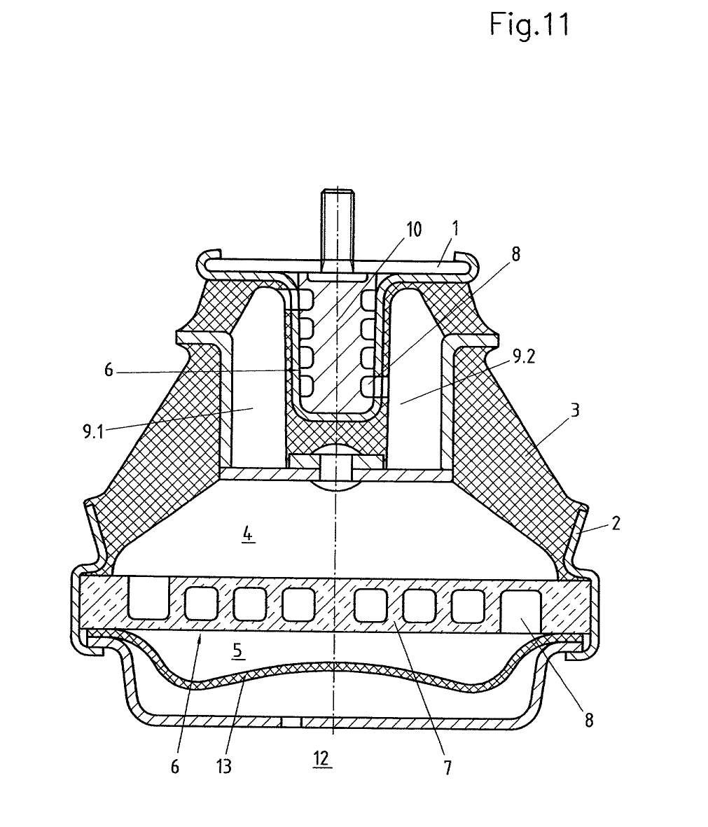

FIG. 11 illustrates a hydraulic bearing which differs from traditional hydraulic bearings which have a damping effect only in the axial direction by a different design in the area of journal bearing 1. Two fluid pockets 9.1, 9.2 are hydraulically separated from working space 4 and/or compensating space 5. The function of the hydraulic bearing which provides the damping effect in the radial direction corresponds to the function of the hydraulic bearing shown in FIG. 8. For damping of low-frequency, high-amplitude vibrations induced in the axial direction of the hydraulic bearing, damping fluid is displaced from working space 4 into compensating space 5 and vice versa. Since the damping fluid inside fluid pockets 9.1, 9.2 is separated from the damping fluid inside working space 4 and compensating space 5, it is possible, for example, to use damping fluids having different viscosities. It is advantageous here that both damping in axial and damping in radial directions can be optimally adapted to the prevailing conditions in the given application.

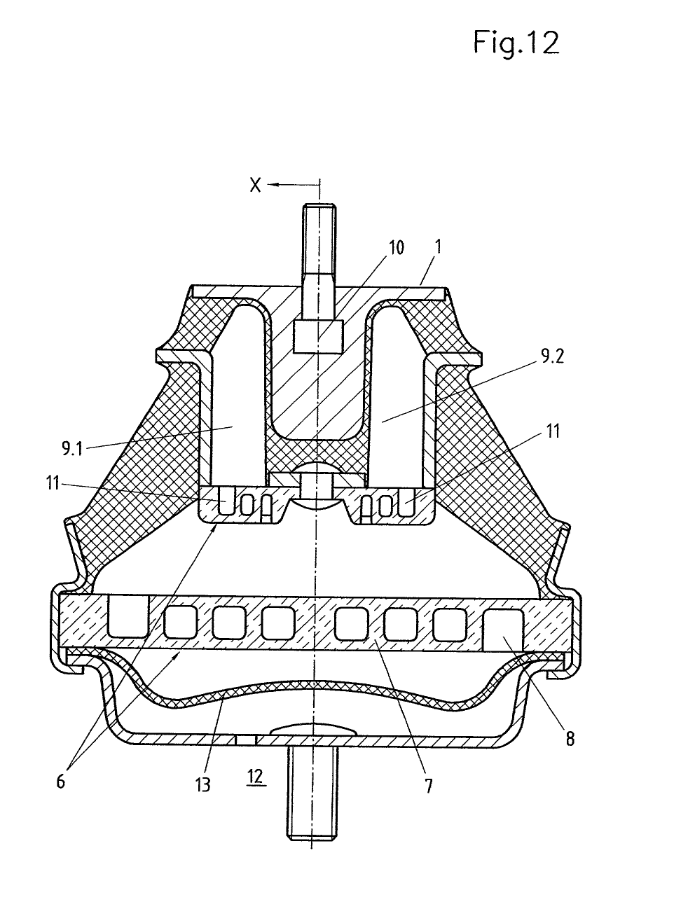

FIG. 12 illustrates another exemplary embodiment of a hydraulic bearing which differs from the hydraulic bearing shown in FIG. 11 in that fluid pockets 9.1, 9.2 are each hydraulically connected to working space 4 through one. throttle opening 11. Throttle opening 11 here may have various designs, e.g., as a throttle aperture or as a channel, as shown here, for example. As journal bearing 1 is displaced radially to supporting bearing 2, the damping fluid. is conducted from one fluid pocket 9.1 into working space 4 through throttle opening 11 which is located next to the fluid pocket in the axial direction, the volume displaced into working space 4 being conveyed out of working space 4 through the corresponding throttle opening 11 and accommodated in the second fluid pocket 9.2 due to the simultaneous enlargement of the second fluid pocket 9.2. If the flow resistance of throttle opening 11 is very large, same as the stiffness of elastic body 3, the hydraulic bearing illustrated here functions in the same way as the hydraulic bearing in FIG. 7. The damping fluid is pumped back and forth between fluid pockets 9.1. and 9.2. However, if the flow resistance of throttle opening 11 is comparatively low, same as the spring stiffness of spring body 3, working space 4 acts as compensating chamber for fluid pockets 9.1 and 9.2.

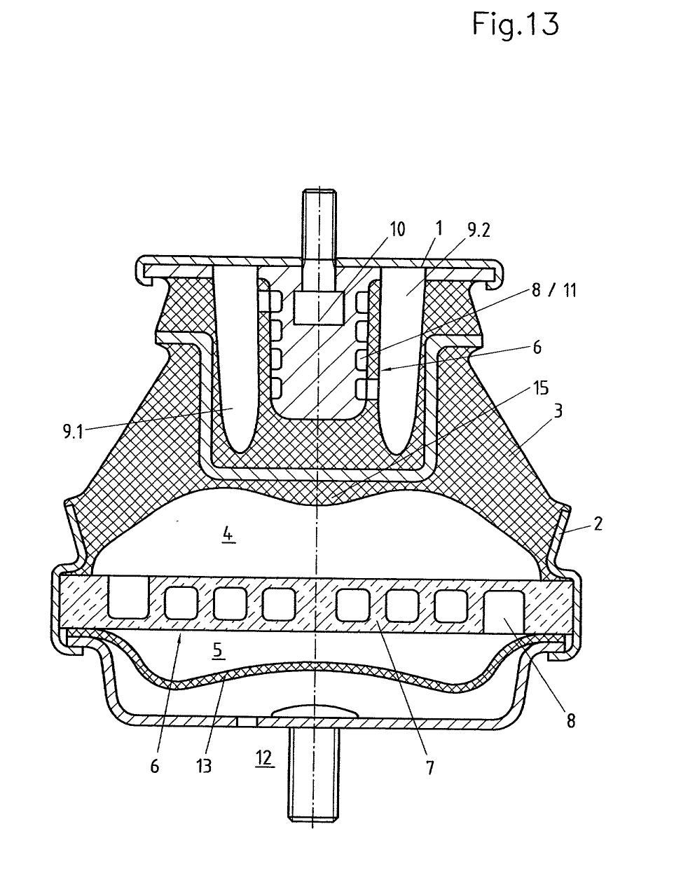

FIG. 13 illustrates another exemplary embodiment which corresponds essentially to the exemplary embodiment in FIG. 11. In deviation from the exemplary embodiment in FIG. 11, this embodiment employs a stop buffer 15 which is designed in one piece with spring body 3 with one developing into the other, and it can be brought to rest against partition 7 to limit axial deflection movements.

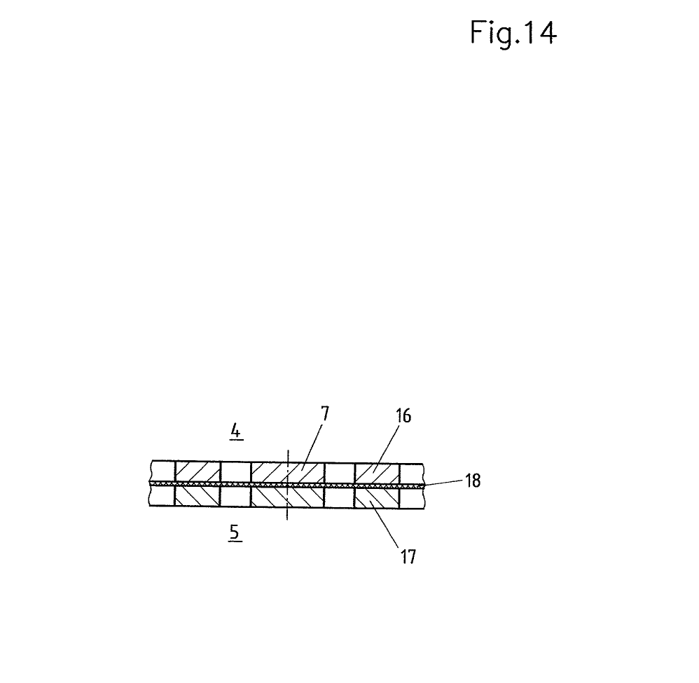

FIG. 14 illustrates an alternative embodiment of a partition 7 formed by a nozzle cage, partition 7 being composed of a top part 16 and a bottom part 17, separated axially by a membrane 18 that can vibrate axially to isolate high-frequency, low-amplitude vibrations. As an alternative, this partition 7 in FIG. 14 may be used instead of partitions 7 in FIGS. 1 through 6 and 11 through 13.

What is claimed is:

1. A hydraulic bearing, comprising: a journal bearing and a supporting bearing which are joined by a spring body made of a rubber elastic material and border on at least one working space and at least one compensating space, the working space and the compensating space being each filled with a damping fluid and communicating through a damping device in a fluid-conducting manner, wherein, in response to relative radial displacement of the journal bearing (1) and the supporting bearing (2) with respect to one another, the damping device (6) can have damping fluid flowing through it.

2. The hydraulic bearing according to claim 1, wherein the damping device (6) is formed by a partition (7) between the working space (4) and the compensating space (5), and the partition (7) has at least one damping channel (8).

3. The hydraulic bearing according to claim 1, wherein the working space (4) and compensating space (5) are arranged adjacent to each other in the axial direction and are separated from each other by the partition (7).

4. The hydraulic bearing according to claim 2, wherein the working space (4) and compensating space (5) are arranged adjacent to each other in the axial direction and are separated from each other by the partition (7).

5. The hydraulic bearing according to claim 1, wherein the working space (4) has at least one variable volume fluid pocket (9) extending in the axial direction.

6. The hydraulic bearing according to claim 2, wherein the working space (4) has at least one variable volume fluid pocket (9) extending in the axial direction.

7. The hydraulic bearing according to claim 3, wherein the working space (4) has at least one variable volume fluid pocket (9) extending in the axial direction.

8. The hydraulic bearing according to claim 5, wherein the fluid pocket (9) is essentially kidney shaped and extends essentially in a semicircle around the core (10) of the journal bearing (1).

9. The hydraulic bearing according to claim 6, wherein the fluid pocket (9) is essentially kidney shaped and extends essentially in a semicircle around the core (10) of the journal bearing (1).

10. The hydraulic bearing according to claim 7, wherein the fluid pocket (9) is essentially kidney shaped and extends essentially in a semicircle around the core (10) of the journal bearing (1).

11. The hydraulic bearing according to claim 1, wherein the working space (4) has two variable volume fluid pockets (9.1, 9.2) extending axially, communicating through at least one throttle opening (11).

12. The hydraulic bearing according to claim 2, wherein the working space (4) has two variable volume fluid pockets (9.1, 9.2) extending axially, communicating through at least one throttle opening (11).

13.. The hydraulic bearing according to claim 3, wherein the working space (4) has two variable volume fluid pockets (9.1, 9.2) extending axially, communicating through at least one throttle opening (11).

14. The hydraulic bearing according to claim 1, wherein the damping channel (8) or the throttle opening (11) is arranged in the core of the journal bearing (1).

15. The hydraulic bearing according to claim 1, wherein the damping channel (8) or the throttle opening (11) is coiled in the core (10).

16. The hydraulic bearing according to claim 11, wherein the two fluid pockets (9.1, 9.2) are separated hydraulically from the working space (4) or the compensating space (5).

17. The hydraulic bearing according to claim 11, wherein the two fluid pockets (9.1, 9.2) are connected to the working space (4) in a fluid-conducting manner.

18. The hydraulic bearing according to claim 11, wherein each of the fluid pockets (9.1, 9.2) is connected to the working space (4) through a damping channel (8) in a fluid-conducting manner.

19. The hydraulic bearing according to claim 1, wherein the compensating space (5) is bordered on the side facing the surroundings (12) by a membrane (13) which is designed like rolling bellows and accommodates a volume essentially without pressure.

20.. The hydraulic bearing according to claim 2, wherein the compensating space (5) is bordered on the side facing the surroundings (12) by a membrane (13) which is designed like rolling bellows and accommodates a volume essentially without pressure.
